(19) United States
(12) Patent Application Publication
(10) Pub. No.: US 2001/0027447 A1
(43) Pub. Date: Oct. 4, 2001

(54) Database apparatus and extended parts table generating apparatus

(76) Inventor: Satoshi Matsuura, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/816,168

(22) Filed: Mar. 26, 2001

(30) Foreign Application Priority Data
Mar. 27, 2000 (JP) 2000-086421

(51) Int. Cl. G06G 7/00

(52) U.S. Cl. 705/400

(57) ABSTRACT

An extended parts table 13 contains information specifying relevant lower level parts or “descendants” for each “parent” part and for each of the relevant lower level parts. The prime cost of a product is calculated based on the extended parts table 13, an item master table containing the purchase unit cost of parts D, E, F and a processing cost master table containing the processing cost of the parts D, E, F. As this eliminates the need for a hierarchical process of calculating the prime cost of a parent part, the processing speed is improved, no complicated application need be developed, and the table need not be updated during run time.

### BACKGROUND OF THE INVENTION

1. Field of the Invention

The present invention relates to a database apparatus and to an extended parts table generating apparatus for use in cost accounting of a product, and more particularly to a database apparatus capable of rapidly performing complicated cost accounting and to an extended parts table generating apparatus used in connection with said database apparatus.

2. Description of Related Art

A typical product consists of a number of parts, each of which may itself be made of yet smaller parts. FIG. 10 is a structured tree of parts constituting an apparatus A, in which the apparatus A consists of one part B and two parts C, the part B consists of two parts D and two parts E, and the part C consists of three parts E and one part F.

Because it is important in the manufacturing industry to understand the production cost for a product, cost accounting is performed using the basic cost of each part and the processing cost required for each assembling process. Typically, lower level parts are designed to be general-purpose to some degree, and their processing cost varies according to the other parts to be used in combination therewith. Therefore, the basic cost is established only for “terminal parts”, namely parts which are not further disassembled (parts D, E, and F in this example), and is not established for parts having lower level parts, such as parts A, B, and C in this example.

Conventionally, when performing such a cost accounting using a database, a cost accounting process similar to that performed manually has been executed. More specifically, the basic cost of a terminal part is multiplied by the number of the terminal parts and to this sum is added the processing fee required for assembling the terminal parts, to thereby obtain the basic cost of a higher level part, and this operation is sequentially executed from lower level to higher level parts (see, for example, Japanese Patent Laid-Open Publication No. Hei 9-34938).

With regard to the example of FIG. 10, various types of tables shown in FIG. 11 are used to perform cost accounting. Referring to FIG. 11, an immediate parts table 1 stores the name of each higher level part (hereinafter referred to as a “parent part”, as appropriate) and each lower level part (hereinafter referred to as a “child part”, as appropriate) having an immediate higher-lower level relationship (hereinafter referred to as “parent-child” relationship) to the parent part, along with the number of child parts required for each parent part. An item master table 2 stores a name of each terminal part D, E, F and the unit purchase cost thereof, and a processing cost master table 3 stores a name and processing cost of each part constituted by child parts, namely A, B, and C.

As described above, the operation of multiplying the unit purchase cost of a terminal part by the number of terminal parts and adding the processing cost required for assembling the terminal parts thereto to thereby obtain the basic cost of a higher level part, is sequentially performed from lower to higher level part in a manner similar to manual processing. However, because the final result depends on the parts which are terminal parts, the following operation is actually performed. First, in order to specify the terminal parts required for a product, all parts in the structured tree are searched in a reverse manner from higher to lower level parts (a so-called “depth-first search”). Then, a product of the unit purchase cost multiplied by the number of parts is obtained for one of the specified terminal parts and for the other terminal parts which share a parent part with said one terminal part. The sum of these products are added to the processing cost required for the terminal parts to thereby obtain the prime cost of the parent part. This operation of obtaining the basic cost, hereinafter referred to as “prime cost”, of a parent part is sequentially performed from lower level parts to higher level parts.

More specifically, a prime cost table 4 is first created which stores names and prime cost of all the parts based on the item master table 2. In the prime cost table 4, the prime cost for the parts other than the terminal parts D, E, F, whose unit purchase cost is already established, is indicated as “NULL”. Then, a “product” is first designated as a parent part, and the prime cost of a child part of the parent part is obtained from the prime cost table 4. When the prime cost of the child part is “NULL” in the table 4, the prime cost of a part at a level immediately lower than the child part (hereinafter referred to as “grandchild part”) is obtained. In this manner, all the parts are searched from higher to lower level along the tree. Since the prime cost of the terminal parts, namely the lowest level parts, is established in the table 4, it is possible to calculate the prime cost of a parent part which is constituted by the terminal parts based on the prime cost and the number of the terminal parts, along with the processing cost in the processing cost master table 3. The prime cost of the parent part thus obtained is substituted for update in the prime cost table 4. By sequentially performing this operation for obtaining prime cost in the lower-to-upper level direction, namely, first for the part B, then for the part C, and finally for the part A, the prime costs for all the parts in the prime cost table 4 are calculated and the data is updated. Finally, the prime cost is multiplied by the number of parts for each of the parts (B, C) whose parent part is the part A in the immediate part table 1, and the result is added with the processing cost (100) in the processing cost master table 3, so that the prime cost of the part A, which is a product, is obtained.

In the prior art example, however, the prime cost of a parent part cannot be obtained unless the prime cost of all child parts is known, and the prime cost of all grandchild parts is required in order to obtain the prime cost of the child part. Thus, in this example, in order to obtain the prime cost of a product in FIG. 10, it is necessary to make ten SQL (Structured Query Language) queries to the database, and to update the database three times. This restricts the increase in the processing speed and also retards the development of application software because a complicated application software must be created for a recursive processing. Also, frequent updating of the table creates a heavy load on system resources.

In view of the above-described problems of the related art, it is an object of the present invention to enable a high processing speed without development of complicated applications and without updating the table during the runtime.

### SUMMARY OF THE INVENTION

According to the present invention, there is provided a database apparatus for calculating the prime cost of a product manufactured by a plurality of parts ranging, from the highest to the lowest level, over a plurality of hierarchical levels, said apparatus comprising an extended parts table containing all combinations of pairs of parts selected from said plurality of parts, each pair of parts having an upper-lower level relationship; an item master table containing information on a price of each of said plurality of parts; and a cost account calculating section for calculating the prime cost of said product based on said extended parts table and said item master table.

Further, in a database apparatus according to the present invention, said cost account calculating section may extract, from said pairs of parts in the extended parts table, pairs of parts, each pair including the highest level part at an upper level, read the price of a lower level part in each of said extracted pairs from said item master table, and add the prices of said extracted pairs together to calculate the prime cost of said product.

Also, in a database apparatus according to the present invention, said extended parts table may contain information on the quantity of lower level parts in said pairs of parts.

Moreover, in a database apparatus according to the present invention, said cost account calculating section may extract, from said pairs of parts in the extended parts table, pairs of parts each including the highest level part at an upper level, read the price of a lower level part in each of said extracted pairs from said item master table, read the quantity of said lower level part from said extended parts table, multiply the price by the quantity, and add the multiplication results of said extracted pairs to calculate the prime cost of said product.

Also, a database apparatus according to the present invention may further comprise a processing cost master table which contains information on the processing cost required for manufacturing each of the parts manufactured by immediate lower level parts, and said cost account calculating section may also use said processing cost master table to calculate the prime cost of said product.

Also, according to the present invention, there is provided a database apparatus for calculating the prime cost of a product manufactured from a plurality of parts ranging, from the highest to the lowest level, over a plurality of hierarchical levels, said apparatus comprising an extended parts table containing all combinations of pairs of parts selected from said plurality of parts, each pair of parts having an upper-lower level relationship and also containing information on the price and the quantity of lower level parts of said pairs of parts; and a cost account calculating section for calculating the prime cost of said product based on said extended parts table.

In a database apparatus according to the present invention, said cost account calculating section may extract, from said pairs of parts in the extended parts table, pairs of parts each including the highest level part at an upper level, read the price and the quantity of a lower level part in each of said extracted pairs from said extended parts table, multiply the price and the quantity of said lower level part together, and add multiplication results of said extracted pairs to calculate the prime cost of said product.

Further, in a database apparatus according to the present invention, said extended parts table may contain information on the processing cost required for manufacturing each of the parts manufactured by immediate lower level parts, and said cost account calculating section may also use said information on the processing cost to calculate the prime cost of said product.

Still further, according to the present invention, there is provided an extended parts table generating apparatus for generating, regarding a product manufactured by a plurality of parts ranging, from the highest to the lowest level, over a plurality of hierarchical levels, based on an item master table containing information on a price for each of said parts and based on an immediate parts table containing information for specifying immediate lower level parts of each of said parts, an extended parts table containing all combinations of pairs of said plurality of parts, each pair of parts having an upperlower level relationship.

### BRIEF DESCRIPTION OF THE DRAWINGS

These and other objects of the invention will be explained in the description below, in connection with the accompanying drawings, in which:

FIG. 1 is a block diagram for schematically showing the structure according to an embodiment of the invention;

FIG. 2 is a flowchart showing an example process according to the embodiment of the present invention;

FIG. 3 is a flowchart showing an example process according to the embodiment of the present invention;

FIG. 4 is an explanatory view showing the extended parts table;

FIG. 5 is an explanatory view showing the extended parts table and the stack in the process of generating the extended parts table;

FIG. 6 is an explanatory view showing the extended parts table and the stack in the process of generating the extended parts table;

FIG. 7 is an explanatory view showing the extended parts table and the stack in the process of generating the extended parts table;

FIG. 8 is an explanatory view showing the extended parts table and the stack in the process of generating the extended parts table;

FIG. 9 is an explanatory view showing a modified example of the extended parts table;

FIG. 10 is a structured tree showing low-high level relationship (parent-child relationship) between parts; and

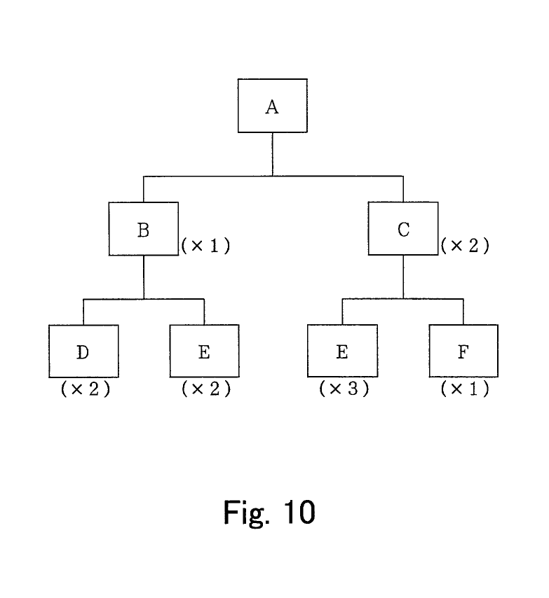

FIG. 11 shows an explanatory diagrams of the immediate parts table, the item master table, the processing cost master table, and the prime cost table, respectively.

### DETAILED DESCRIPTION OF THE PREFERRED EMBODIMENT

A preferred embodiment of the present invention will be described in further detail with reference to the accompanying drawings.

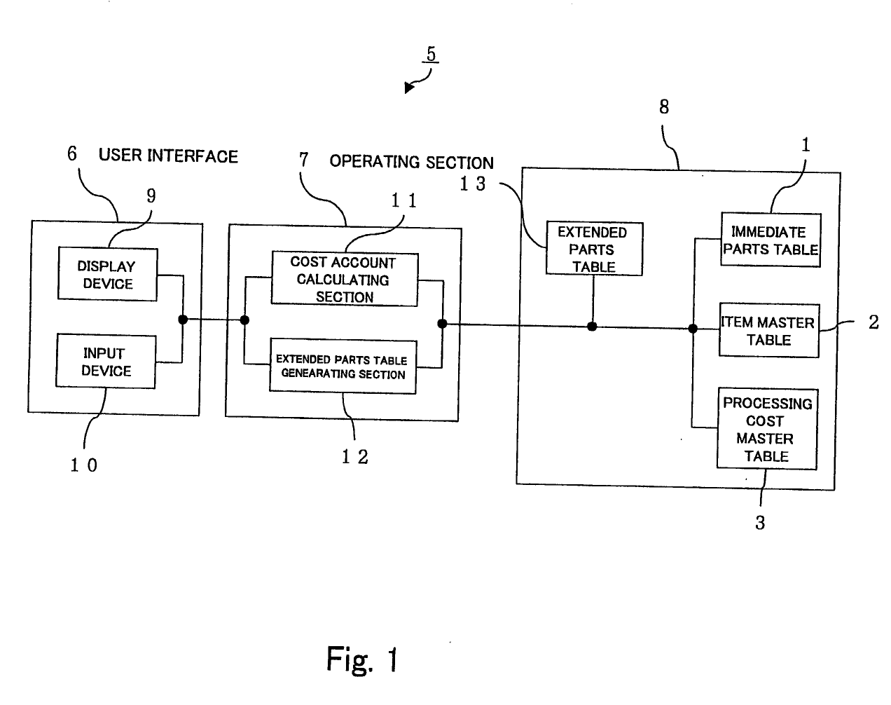

FIG. 1 is a schematic structural view showing a database apparatus 5 according to the preferred embodiment of the present invention. Referring to FIG. 1, the database apparatus comprises a user interface 6 for transmitting/receiving information to/from an user, an operating section 7 for performing operations in response to various inputs based on a user input or the like and outputting the results, and a database 8.

The user interface 6 includes a display device 9 which is, in this example, a CRT and an input device 10 which is a keyboard and a mouse. The operating section 7 includes a cost account calculating section 11 and an extended parts table generating section 12. The database 8 stores an immediate parts table 1, an item master table 2, and a processing cost master table 3.

The database apparatus 5 in this embodiment constitutes, as a hardware, a computer system comprising a central processing unit (CPU), a memory, a hard disc apparatus, and above-described display device 9 and the input device 10, in which various computer programs and the database 8 are stored in the hard disc apparatus in the form of text or binary data.

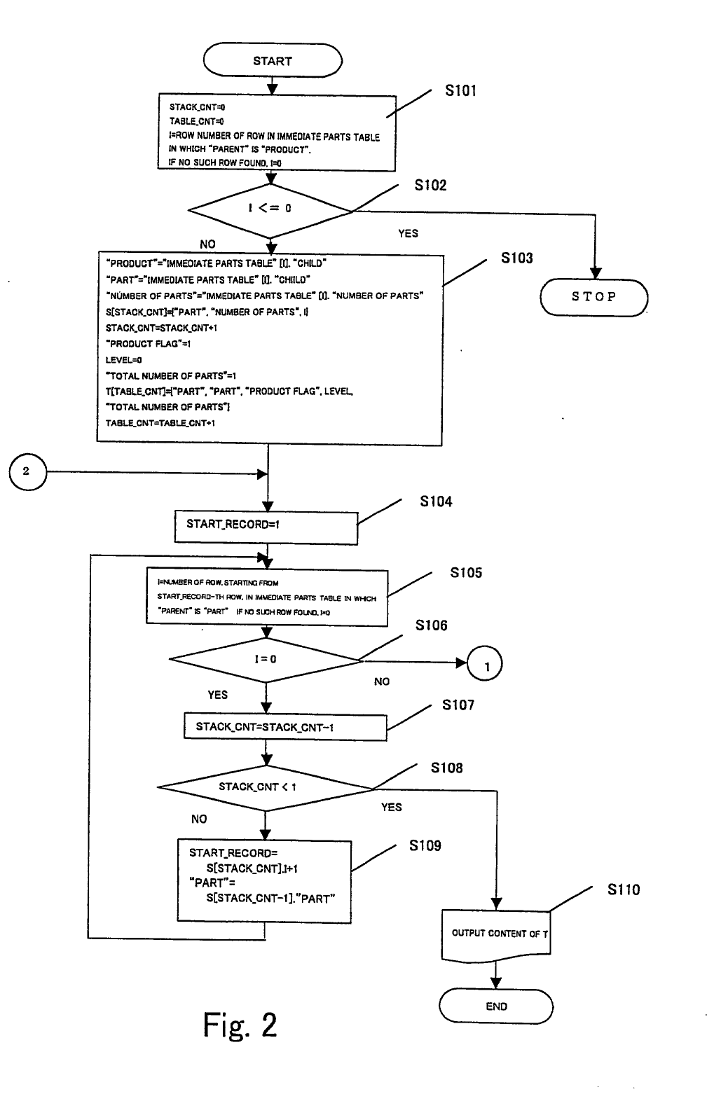

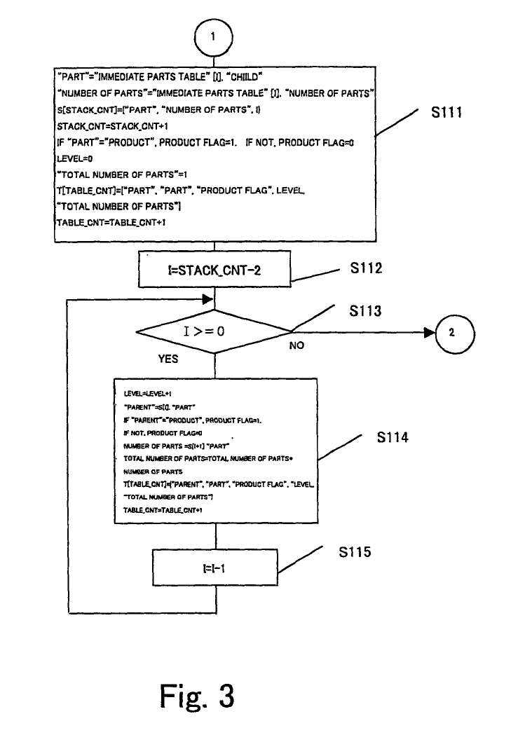

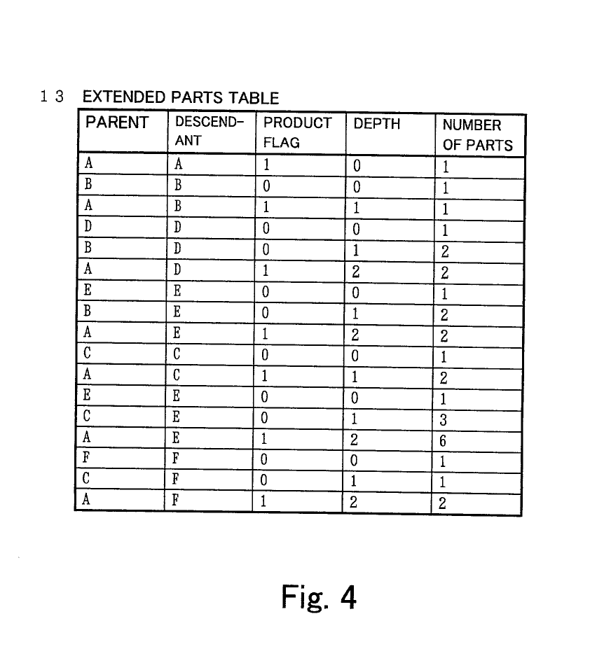

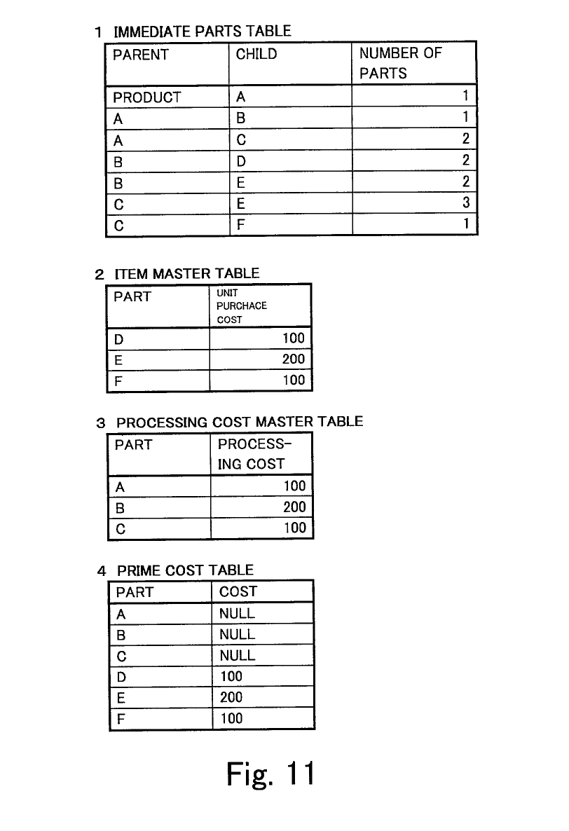

FIGS. 2 and 3 are flowcharts showing a process of generating an extended parts table according for use in this embodiment of the present invention. This process is performed by the extended parts table generating section 12 to generate an extended parts table 13 shown in FIG. 4 based on the immediate parts table 1 and the item master table 2 shown in FIG. 11 which are the same as those used for the above-explained prior art system. The “extended parts table” as discussed here refers to a table which contains, on a one-to-one basis, information specifying not only parts having immediate parent-child relationship with a certain part, but also lower level parts of all level hierarchies with regard to a certain part (that is, all the parts used to produce the certain part), such as grandchild parts of the certain part and the child and grandchild parts of said grandchild parts. In the process shown in the flowchart of FIGS. 2 and 3, variables including S(stack), T(extended parts table), STACK_CNT (the maximum value of S, namely stack counter value), TABLE_CNT (the maximum value of T, namely table counter value), I, “product” r, “part”, “number of parts”, “product flag”, and START_RECORD (reading start record number) are used.

Referring to FIG. 2, the initial values are set, and 0 is set to both the stack counter value and the table counter value. At the same time, through the immediate parts table 1, a row is searched in which the “parent” is a “product”, and the row number of that row is assigned to I. When no such row is found, 0 is set to I (S101). In this example, a set of {“product” “A”, 1} is found at the first row, and therefore 1 is set to I.

It is then determined whether or not I is 0 or less (S102). If I is 0, there are no parts whose parent is a “product”, which means the immediate parts table 1 contains no parts which constitute the target “product”, and therefore the process should be terminated. In this example, as I=1>0, NO is determined in step S102.

When NO is determined in step S102, a conversion process is performed with regard to a part which itself is a “product” (namely, part A in this example) (S103). First, the value of a “child” in the I-th row (the first row in this example) in the immediate parts table 1, namely “A”, is assigned to the “product” and the “part”. At the same time, the value of “number of parts” in the I-th row (the first row in this example) of the immediate parts table 1, namely 1, is assigned to the “number of parts”.

Then, a value set of {“part”, “number of parts”, I}, namely {A, 1, 1} is assigned to the stack S[STACK CNT], and the value of STACK_CNT +1, namely 1, is given to the stack counter value.

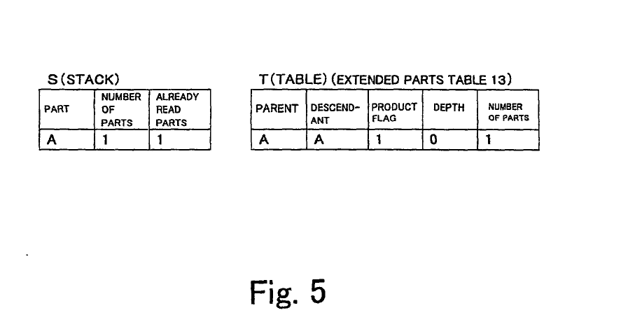

Further, 1 is assigned to the “product flag”, 0 is assigned to the “LEVEL”, and 1 is assigned to the “total number of parts”. Then, a value set of {“part”, “part”, “product flag”, “LEVEL”, “total number of parts” }, namely {A, A, 1, 0, 1} is assigned to the extended parts table value T[TABLE_CNT], thereby generating the first row of the extended parts table 13 as shown in FIG. 5. Finally, the value of TABLE_CNT+1, namely 1, is set to a table counter value. The above is a conversion process regarding a part which is a “product” as it is (the part A in this example). In the extended parts table 13, at the row processed by the step S103 (only the first row in this example), 1 is assigned to the “product flag” and 0 is assigned to the “depth”.

In the following step S104, 1 is assigned to the reading start record number START_RECORD (S104).

Next, in step S105, through the immediate parts table 1, a row in which the “parent” is the “part” (namely the part A) is searched, starting from the row numbered with the value of START_RECORD (namely the first row). When such a row is found, the row number of that row is assigned to I. When no such row is found, 0 is set to I. In this example, since a value set of {A, B, 1} is found at the second row, the value of this row, namely 2, is assigned to I.

It is then determined whether or not I=0 (S106). If I is 0, there are no parts whose parent is the “part” (namely the part A), which means the immediate parts table 1 contains no parts which constitute the part A, and therefore a process regarding terminal parts as will be described below should be executed. In this example, as I=2>0 now, NO is determined and the process advances to the routine in FIG. 3.

In the process routine shown in FIG. 3, a conversion process regarding the case where both values of the “parent” and the “descendant” are the “child part”, namely a process of generating information as to the child part itself, is first performed (Slll). Specifically, the value of the “child” at the I-th row (the second row in this example) in the immediate parts table 1, namely B, is set to the “part”. Also, the value of “number of parts” at the I-th row (the second row in this example) in the immediate parts table 1, namely 1, is assigned to the “number of parts”.

Then, a value set of {part“, ” number of parts“, I}, namely {B, 1, 2} is assigned to the stack S[STACK_CNT] at the second row. Further, the value of STACK_CNT+1, namely 2, is assigned to the stack counter value.

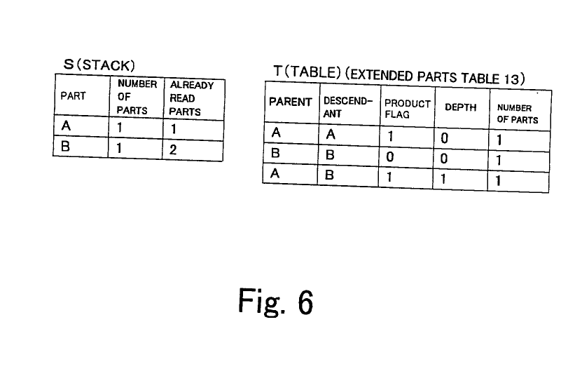

Also, 0 is set to the “product flag”, 0 is set to “LEVEL”, and 1 is set to “total number of parts”. The value set of _{“part”, “part”, “product flag”, “LEVEL”, “total number of parts” }, namely {B, B, 0, 0, 1} is then assigned to the extended parts table value T[TABLE_CNT], thereby generating the second row of the extended parts table 13 as shown in FIG. 6. Finally, value of TABLE_CNT+1, namely 2, is assigned to the table counter value. This is the conversion process regarding information on a child part itself. In the extended parts table 13, at the rows processed by the step S111 (the 2^{nd} , 4^{th}, 7^{th}, 10^{th}, 12^{th}, and 15^{th} rows in this example), 0 is assigned to both the “product flag” and the “depth”.

Next, in step S112, the value of STACK_CNT - 2, namely 0, is set to I. It is then determined whether or not I≧0 at step S113. If I, being the value of STACK_CNT - 2, has a negative value, the part is at the highest level in a stack, which means there are no parent parts of the part in a low-level to high-level search, and, therefore, the conversion process should be terminated so that the output process as will be described later is executed according to the contents of the extended parts table 13. In this example, as I=0≧0, YES is determined and the process advances to step S114.

When there is a relationship between a parent part and a part relevant to the parent part (which will be referred to as a “descendant part”, as required), a conversion process is performed in step S114 . First, the value of LEVEL+1, in this case 1, is set to LEVEL. Also, the value of the “part” at the row numbered with [I] (that is, the row numbered with 0, namely the first row) of the stack S, namely A, is set to “parent”. (Note that in the stack S, the first row is numbered with 0) In addition, 1 is assigned to the “product flag” if the “parent” is a product, and otherwise 0 is assigned.

Further, the value of the “number of parts” at the row numbered with [I+1] (that is, the row numbered with 1, namely the second row in this example), namely 1, is set to “number of parts”. Also, the value of the “number of total parts” * “number of parts”, namely 1, is set to the “number of total parts” (1 in this example) set in the previous step Sill.

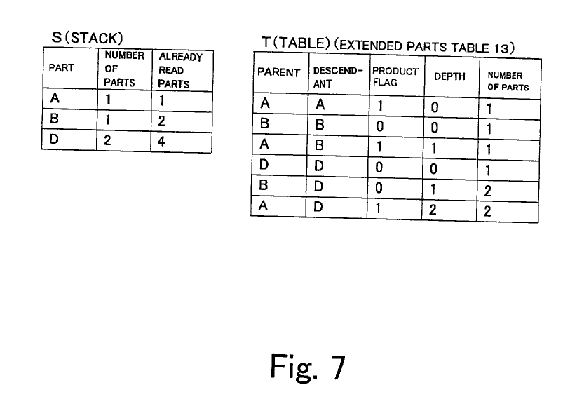

Then, a data set of {“parent”, “part”, “product flag”, “LEVEL”, “total number of parts” }, namely {A, B, 1, 1, 1} is assigned to the extended parts table value T[TABLE_CNT], thereby generating the third row of the extended parts table 13 as shown in FIG. 7. Finally, the value of TABLE_CNT+1, namely 3, is assigned to the table counter value (step S114). The above is the conversion process for a descendant regarding the parent-descendant relationship with a parent part. In the extended parts table 13, at the rows processed by the step S114 (the 3^{rd}, 5^{th}, 6^{th}, 8^{th}, 9^{th}, 11^{th}, 13^{th}, 14th, 16^{th} and 17^{th} rows in this example), values other than 0 are assigned for the “depth” column, according to the hierarchy difference between the descendant and the parent part.

In the following step S115, the value of I−1, namely −1, is set to I (0 in this example). This is directed for searching a parent part of the part from lower to higher level.

Next, in step 113, it is again determined whether or not I >0. Since I=(−1)<0 this time, a NO determination results and the process advances to the step S104 in the process routine of FIG. 2.

In step S104, 1 is set to the reading start record number START_RECORD as is the previous time. Then, in step S105, starting from the row numbered with the value START RECORD (namely the first row), a row at which the “parent” is the “part” (namely, the part B) is searched through the immediate parts table 1. If such a row is found, the row number of that row is assigned to I. If no such row is found, I=0 is set. In this example, the fourth row indicates {B, D, 2}, and therefore the row number 4 is assigned to I.

Next, it is determined, at step S106, whether or not I=0, as in the previous time. Since I=4>0 this time, the process goes to the routine in FIG. 3. In other words, until I=0 is established at step S105, namely as long as there are still child parts which share a common parent part with the parts which are already subjected to conversion processing, the process routine in FIG. 3 is repeated. Then, when I=0 is established, namely when there are no other child parts which share the common parent part, the process advances to the next step S107 for processing the parent part.

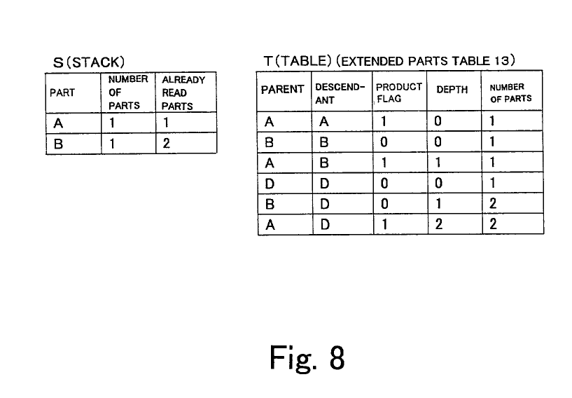

At step S107, in order to reduce the stack, the value STACK_CNT-1 is set to the stack counter value. Although the stack counter value is thus reduced so that apparently the third row of the stack S is not displayed as shown in FIG. 8, the data regarding the third row of the stack S is actually preserved without being cleared. It is then determined, at step S108, whether or not the stack counter value is less than 1. If the stack counter value is less than 1, the part is at the highest level in the stack, which means that there is no parent part of the part in the low-level to high-level search. Therefore, the conversion process is then terminated so that the output process, as will be described later, is performed according to the contents of the extended parts table 13. Here, as long as the stack counter value is 1 or more, the determination at step S107 is NO and the process advances to step S109.

In step S109, the value of I at the [STACK_CNT]-th row in the stack S (that is the value of “already read parts” in the stack S)+1 is set to the reading start record number START-RECORD. For example, if the stack counter value STACK_CNT is 2, an input value of 5 is obtained by adding 1 to the value of “already read parts” at the third row of the stack S (namely 4). At the same time, the value of the “part” at the [STACK_CNT-1]-th row in the stack, that is B, for example, is assigned to the “part”. This operation is performed to renew the search target or, in other words, to change the process into a search process as to whether or not there is still another child part sharing the common parent part. In this manner, at steps S105 to S109, the process goes back to step S105 when it is determined that the parent part has no unconverted child parts, and this process is repeated. Here, the reason why 1 is added to the value of “already read parts” at the [STACK CNT]-th row in the stack S in the setting of reading start record number START_RECORD as described above is to prevent the same row in the immediate parts table 1 from being read twice.

In this manner, the extended parts table 13 is generated row by row, and, finally, when the stack counter value is less than 1 at step S108, the part is at the highest level of the stack, which means that there are no parent parts for the part in the low-level to high-level search. Therefore, the conversion process is terminated such that the process advances to step S110 for outputting the contents of the extended parts table 13. This output process is carried out, for example, by creation of a data file containing the contents of the extended parts table 13, display on the display device 9 and/or output from the printer (not shown). The conversion process is thus terminated, and the extended parts table 13 is completed as shown in FIG. 4.

When performing cost accounting using this extended parts table 13, the following operation is executed in the cost account calculating section 11.

[Expression 1]

SELECT SUM (“price”) FROM

SELECT SUM (“number of parts” * “purchase unit cost”) “price” FROM “extended parts table”, “item master table” WHERE “descendant”=“part” AND “parent”=“A” UNION

SELECT SUM (“number of parts” * “processing cost”) “price” FROM “extended parts table”, “processing cost master table” WHERE “descendant”=“part” AND “parent” =“A” ) AS TABLE.

According to the operation of the expression 1, the cost account calculating section 11 performs the following processing.

First, from the extended parts table 13, all rows in which the “descendant” is any one of the terminal parts and the “parent” is a part at the highest level are extracted. Then, for each of the extracted rows, the “unit purchase cost” obtained from the item master table 2 and the “number of parts” obtained from the extended parts table 13 are multiplied, and the multiplication results for all the extracted rows are added, to thereby obtain the “unit purchase cost” of a product.

Next, from the extended parts table 13, all rows in which the “descendant” is any one of the non-terminal parts and the “parent” is a part at the highest level are extracted. Then, for each of the extracted rows, the “processing cost” obtained from the processing cost master table 3 and the “number of parts” obtained from the extended parts table 13 are multiplied, and the multiplication results for all the extracted rows are then added together to obtain the “processing cost” of the product.

The “unit purchase cost” and the “processing cost”, which are obtained as described above, are further added together to obtain the prime cost value of the product.

The above processing will be described in more detail.

In calculation of the “unit purchase cost”, from the rows of the extended parts table 13, all rows in which the item of the “descendant” is “D”, “E”, or “F”, each of which is assigned as a “part” in the item master table 2, and the item of the “parent” is “A”, which is a part at the highest level, are extracted. As a result, the 6^{th}, 9^{th}, 14^{th} and 17^{th} rows are extracted from the extended parts table 13. Then, for each of the extracted rows, the value of the “unit purchase cost” of the part assigned as the “descendant” is read from the item master table 2, and the value of the “unit purchase cost” is multiplied with the value of the “number of parts” in the extended parts table 13.

More specifically, in the 6^{th} row of the extended parts table 13, because here “D” is set to the “descendant”, the value “100” is obtained as the “unit purchase cost” from the item master table 2. Also, as the “number of parts” in the 6^{th} row is 2, 200 (100×2) is obtained. Similarly, in the 9^{th} row of the extended parts table 13, because “E” is set to the “descendant” here, the value “200” is obtained as the “unit purchase cost” from the item master table 2. Further, as the “number of parts” in the 9^{th} row is 2, 200×2, or 400, is obtained.

Also, in the 14th row of the extended parts table 13, since “E” is set to the “descendant” here, the value “200” is obtained as the “unit purchase cost” from the item master table 2. Also, as the “number of parts” in the 14^{th} row is 6, 200×6=1200 is obtained. Similarly, in the 17^{th} row of the extended parts table 13, since “F” is set to the “descendant”, the value “100”, is obtained as the “unit purchase cost” from the item master table 2. Further, as the “number of parts” in the 17^{th} row is 2, 100×2=200 is obtained. Then, all the multiplication results thus obtained are added together, to obtain the total value of the “unit purchase cost” of (200+400+1200+200), or 2000.

Next, for calculation of the “processing cost”, from the rows of the extended parts table 13, all rows in which the item of the “descendant” is “A”, “B”, or “C”, which are assigned as a “part” in the processing cost master table 3, and the item of the “parent” is “A”, which is a part at the highest level, are extracted. As a result, the 1^{st}, 3^{rd} and 11^{th} rows in the extended parts table 13 are extracted. Then, for each of the extracted rows, the value of the “processing cost” of the part assigned as the “descendant” is read from the processing cost master table 3, and the value of the “processing cost” is multiplied with the value of the “number of parts” in the extended parts table 13.

More specifically, in the 1^{st} row of the extended parts table 13, because “A” is set to the “descendant” here, the value “100” is obtained as the “processing cost” from the processing cost master table 3. Also, as the “number of parts” in the 1^{st} row is 1, 100 (100×1) is obtained. Similarly, in the 3^{rd} row of the extended parts table 13, because “B” is set to the “descendant” here, the value “200” is obtained as the “processing cost” from the processing cost master table 3. Further, as the “number of parts” in the 3^{rd} row is 1, 200×1, or 200 is obtained.

Also, in the 11^{th} row of the extended parts table 13, because “C” is set to the “descendant” here, the value “100” is obtained as the “processing cost” from the processing cost master table 3. Also, as the “number of parts” in the 11^{th} row is 2, 200 (100×2) is obtained. Then, all the multiplication results obtained are added to obtain the total value of the “processing cost”, (100+200+200), or 500.

The total value of the “unit purchase cost”, 2000, and the total value of the “processing cost”, 500, as obtained in the above-mentioned operation are then added to obtain the prime cost of the product, 2500.

As described above, according to this embodiment, the extended parts table 13 contains information which specifies relevant lower-level parts (namely, data of “descendants”) with regard to each part and with regard to each of said relevant lower-level parts. Thus, the extended parts table 13 contains all possible combinations of pairs of parts. Therefore, the cost account calculating section 11 can calculate the prime cost of a product based on the extended parts table 13 and the item master table 2, thereby eliminating the need of the hierarchical process of calculating the prime cost of a parent part after calculation of the prime cost of grandchild parts and child parts thereof, and also reducing the number of inquiries to the database 8. As a result, the processing speed is increased and the application software can be created very easily due to the elimination of a recursive processing. Further, frequent update of the database 8 during an operation is not required and, as a result, the amount of system resources used for cost accounting can be reduced.

Further, the extended parts table 13 contains information on the number of lower level parts relevant to each part, so that the cost accounting which takes consideration of the necessary quantity of each lower level part can be performed even if a plurality of lower parts of the same type are used.

Still further, the processing cost master table 3 contains information on the processing cost for manufacturing a part which is manufactured by immediate lower level parts, regarding each of the parts to be manufactured, and the cost account calculating section calculates the prime cost of a product using the information contained in the processing cost master table 3 as well. Therefore, when the processing cost is in each assembling process is desired in addition to the prime cost of each part, the cost accounting which takes such processing cost into consideration can be performed.

Also, because the process routine of FIGS. 2 and 3 is executed by the database apparatus 5 of the present embodiment, it is possible to easily provide the extended parts table 13 for use in the above-mentioned cost accounting based on the item master table 2 and the immediate parts table 1.

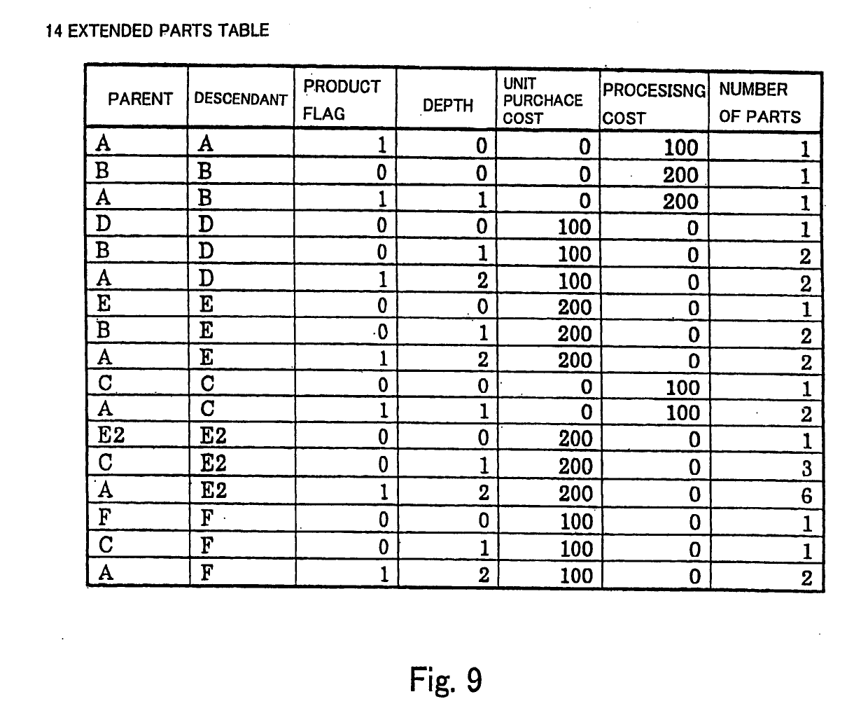

In the foregoing embodiment, the extended parts table 13, the item master table 2, and the processing cost master table 3 are individually provided. As an alternative to this structure, however, it is also possible to create and use an extended parts table 14 shown in FIG. 9 containing the data on the “unit purchase cost” in the item master table 2 and the data on the “processing cost” in the processing cost master table 3, so that the cost accounting can be performed using only this extended parts table 14. In this modified example, the processing cost of the part which is designated as a “descendant” in the extended parts table 14 is read out of the processing cost master table 3 and integrated into the extended parts table 14 as the data on the “processing cost”. Similarly, the unit purchase cost of the part which is designated as a “descendant” in the extended parts table 14 is read out of the item master table 2 and integrated into the extended parts table 14 as the data on the “unit purchase cost”. Further, because a part E may be a descendant of the part A, which is a product, via the part B or via the part C, the part E in such a case is referred to as the part E2 for differentiation purpose.

In order to execute the cost accounting using the extended parts table 14 of this modified example, the cost account calculating section 11 performs the following operation defined in the expression 2.

[Expression 2]

SELECT SUM ((“price”+“processing cost”) * “number of parts”) FROM “extended parts table” WHERE “parent”=“A”

According to the operation of the expression 2, the cost account calculating section 11 performs the following processing.

First, from the rows of the extended parts table 14, all rows in which the “parent” is a part at the highest level are extracted. For each of the thus extracted rows, an operation of ((“unit purchase cost”+“processing cost”)×“number of parts”) is performed, and all the results thus obtained are added to obtain the prime cost value of a product.

The above processing will be described in more detail.

First, from the extended parts table 14, all rows are extracted in which the “parent” is “A”, which is a part at the highest level. As a result, the 1^{st}, 3^{rd}, 6^{th}, 9^{th}, 11^{th}, 14^{th}, and 17^{th} rows in the extended parts table 14 are extracted. Then, for each of the thus extracted rows, the value of the “unit purchase cost” and the value of the “processing cost” are added, and the sum thus obtained is multiplied by the value of the “number of parts”. More specifically, in the b 1^{st} row of the extended parts table 14, because the values of “unit purchase cost”, “processing cost”, and “number of parts” are 0, 100, and 1, respectively, the multiplication value of ((0+100)×1), or 100 is obtained. Similarly, the multiplication value of 200, ((0+200)×1), is obtained for the 3^{rd} row, the multiplication value of 200 ((100+0)×2) is obtained for the 6^{th} row, the multiplication value of 400 ((200+0)×2) is obtained for the 9th row, the multiplication value of 200 ((0+100)×2) is obtained for the 11^{th} row, the multiplication value of 1200 ((200+0)×6) is obtained for the 14^{th} row, and the multiplication value of 200 ((100+0)×2) is obtained for the 17^{th} row. These figures are all added together to obtain the prime cost value of the product, which is 2500. According to this modified example, the single extended parts table 14 contains information on the processing cost and the purchase unit cost as well, such that access to the extended parts table 14 is only needed for the cost account calculating section 11, thereby further increasing the processing speed.

Although in example of the foregoing embodiment implementation of the present invention in a stand-alone system was described, the present invention may also be implemented as a client-server system. For example, the extended parts table generating section 12 may be provided on the side of the server machine while other functions may be provided on the side of the client machine. Any such structures may be employed and fall within the scope of the present invention.

As described above, according to this embodiment, the extended parts table is provided which contains information which specifies relevant lower-level parts with regard to each part and with regard to each of said relevant lower-level parts. Therefore, the cost account calculating section can calculate the prime cost of a product based on the extended parts table and the item master table, thereby eliminating the need of the hierarchical process of calculating the prime cost of a parent part after calculation of the prime cost of grandchild parts and child parts thereof, and also reducing the number of inquiries to the database. As a result, the processing speed is increased and the application software can be created very easily due to the elimination of a recursive processing. Further, frequent updating of the database during an operation is not required, and the burden to system for cost accounting can be reduced.

Further, the extended parts table contains information on the number of lower level parts relevant to each part, so that the cost accounting which takes consideration of the necessary quantity of each lower level part can be performed even when a plurality of lower parts of the same type are used.

Still further, the processing cost master table may contain information on the processing cost for manufacturing a part manufactured by immediate lower level parts, and the cost account calculating section may calculate the prime cost of a product using the information contained in the processing cost master table as well. In this manner, when the processing cost of each assembling process is desired in addition to the prime cost of each part, cost accounting which takes such processing cost into consideration can be performed.

According to the present invention, the extended parts table contains information for specifying the relevant lower level parts, information on the price and quantity of the lower level part, and information on the processing cost required for manufacturing a part which is manufactured by immediate lower level parts. Therefore, access to the single extended parts table is only needed for the cost account calculating section, thereby further increasing the processing speed.

Also, according to the present invention, the extended parts table for use in the above-mentioned cost accounting can be easily provided based on the item master table and the immediate parts table.

While the preferred embodiment of the present invention has been described using specific terms, such description is for illustrative purposes only, and it is to be understood that changes and variations may be made without departing from the spirit or scope of the appended claims.

What is claimed is:

1. A database apparatus for calculating the prime cost of a product manufactured by a plurality of parts ranging, from the highest to the lowest level, over a plurality of hierarchical levels, said apparatus comprising:
an extended parts table containing all combinations of pairs of parts selected from said plurality of parts, each pair of parts having an upper-lower level relationship;
an item master table containing information on a price of each of said plurality of parts; and
a cost account calculating section for calculating the prime cost of said product based on said extended parts table and said item master table.

2. A database apparatus according to claim 1, wherein said cost account calculating section extracts, from said pairs of parts in the extended parts table, pairs including the highest level part at an upper level, reads the price of a lower level part in each of said extracted pairs from said item master table, and adds the prices of said extracted pairs to calculate the prime cost of said product.

3. A database apparatus according to claim 1, wherein said extended parts table contains information on the quantity of lower level parts in said pairs of parts.

4. A database apparatus according to claim 3, wherein said cost account calculating section extracts, from said pairs of parts in the extended parts table, pairs including the highest level part at an upper level, reads the price of a lower level part in each of said extracted pairs from said item master table, reads the quantity of said lower level part from said extended parts table, multiplies the price by the quantity, and the adds the multiplication results of said extracted pairs to calculate the prime cost of said product.

5. A database apparatus according to any one of claim 1 to claim 4 further comprising a processing cost master table which contains information on the processing cost required for manufacturing each of the parts manufactured by immediate lower level parts,
wherein said cost account calculating section also uses said processing cost master table to calculate the prime cost of said product.

6. A database apparatus for calculating the prime cost of a product manufactured by a plurality of parts ranging, from the highest to the lowest level, over a plurality of hierarchical levels, said apparatus comprising:
an extended parts table containing all combinations of pairs of parts selected from said plurality of parts, each pair of parts having an upper-lower level relationship and also containing information on the price and the quantity of lower level parts of said pairs of parts; and
a cost account calculating section for calculating the prime cost of said product based on said extended parts table.

7. A database apparatus according to claim 6, wherein said cost account calculating section extracts, from said pairs of parts in the extended parts table, pairs of parts each including the highest level part at an upper level, reads the price and the quantity of a lower level part in each of said extracted pairs from said extended parts table, multiplies the price by the quantity of said lower level part, and adds multiplication results of said extracted pairs to calculate the prime cost of said product.

8. A database apparatus according to claim 6 or claim 7, wherein said extended parts table contains information on the processing cost required for manufacturing each of the parts manufactured by immediate lower level parts, and said cost account calculating section also uses said information on the processing cost to calculate the prime cost of said product.

9. An extended parts table generating apparatus for generating, regarding a product manufactured by a plurality of parts ranging, from the highest to the lowest level, over a plurality of hierarchical levels, based on an item master table containing information on a price for each of said parts and based on an immediate parts table containing information for specifying immediate lower level parts of each of said parts, an extended parts table containing all combinations of pairs of said plurality of parts, each pair of parts having an upper-lower level relationship.
